(19) United States
(12) Patent Application Publication
(10) Pub. No.: US 2008/0231173 A1
(43) Pub. Date: Sep. 25, 2008

(54) ELECTRO-LUMINESCENT DEVICE AND METHOD FOR MANUFACTURING THE SAME

(76) Inventor: Dae Hyun Park, Yongin-si (KR)

Correspondence Address: KED & ASSOCIATES, LLP, P.O. Box 221200, Chantilly, VA, 20153-1200, US

(21) Appl. No.: 12/050,391

(22) Filed: Mar. 18, 2008

(30) Foreign Application Priority Data
Mar. 19, 2007 (KR) 10-2007-0026663

(51) Int. Cl. F21V 9/16; B05D 5/12

(52) U.S. Cl. 313/503; 427/66

(57) ABSTRACT

A method for manufacturing an electro-luminescent device includes forming an electrode on an insulating substrate, forming a dielectric layer over the electrode using a green sheet method and simultaneously curing the electrode and the dielectric layer.

### BACKGROUND

1. Field

One or more embodiments described herein relate to display devices.

2. Background

Electro-luminescence is widely used in light emitting devices. For example, an inorganic electro-luminescent device may be used to form a flat panel display device. In an inorganic electro-luminescent device, electrons accelerated by a high electric field strike phosphors, thereby causing the phosphors to emit light. Such a device has advantages of high brightness, long lifespan, high resolution, etc. However, existing methods for manufacturing electroluminescent displays tend to have too many process steps, which increase complexity and manufacturing costs. Also, many of these devices are inefficient in terms of power consumption.

### BRIEF DESCRIPTION OF THE DRAWINGS

The embodiments will be described in detail with reference to the following drawings in which like reference numerals refer to like elements, wherein:

FIG. 1 is a sectional view showing the formation of a lower electrode and a lower dielectric layer of one embodiment of a display device;

FIG. 2 is a sectional view showing a state in which the layers of FIG. 1 have been simultaneously cured;

FIG. 3 is a sectional view showing the formation of a planarizing layer in the structure of FIG. 1;

FIG. 4 is a sectional view showing an example of how a phosphor layer may be formed over the planarizing layer;

FIG. 5 is a sectional view showing the formation of an upper dielectric layer and an upper electrode over the phosphor layer;

FIG. 6 is a sectional view showing the formation of a color correcting layer and a passivation layer over the upper electrode;

FIG. 7 is a sectional view showing another example of the phosphor layer that may be formed in the display device;

FIG. 8 is a sectional view showing the formation of a color converting layer over the phosphor layer, together with the upper dielectric layer and upper electrode;

FIG. 9 is a diagram showing one way in which the color converting layer may function;

FIG. 10 is a sectional view showing the formation of a lower electrode on an insulating substrate of a second embodiment of a display device;

FIG. 11 is a sectional view showing formation of a lower dielectric layer of the device of FIG. 10;

FIG. 12 is a sectional view showing formation of a planarizing layer in the device of FIG. 10;

FIG. 13 is a sectional view showing an example of red, green, and blue phosphor layers that may be formed in the device of FIG. 10; and

FIG. 14 is a sectional view showing an example of a blue phosphor layer and a color converting layer that may be included in the device of FIG. 10.

### DETAILED DESCRIPTION

An inorganic electro-luminescent device may be configured on a substrate that includes a phosphor layer emitting light, and dielectric layers and electrodes arranged at opposite sides of the phosphor layer. Each dielectric layer has breakdown characteristics, provides protection against external impurities, and thus contributes to the stability of the device. Each dielectric layer also determines light emission efficiency and brightness characteristics in accordance with the condition of the interface of the dielectric layer with the phosphor layer.

The dielectric layers should exhibit high breakdown field characteristics, in order to contribute to the stability of the device. The dielectric layers should also have a high dielectric constant, in order to achieve a reduction in threshold voltage and thus to improve brightness of the device.

At least one of the dielectric layers may be formed using a printing method such as a screen printing process using a paste. Where such a printing method is used, formation of the dielectric layer is achieved by repeating the printing process and a curing process several times. These processes are repeated in order to obtain a uniform dielectric surface. That is, when the dielectric is coated one or two times, the printing method produces a rough surface after it is dried. For this reason, the procedure of coating a thin dielectric layer and forming an interlayer over the thin dielectric layer is repeated until a desired thickness is obtained.

In many devices, the lower dielectric layer has a large thickness in order to generate a high electric field. In order to form such a layer, an increased number of processes is required. This has the effect of increasing manufacturing time. Also, when the dielectric layer is formed by conducting a coating process one or two times in accordance with the printing method, cracks may form in the dielectric layer. These cracks may cause severe degradation in the performance of the device.

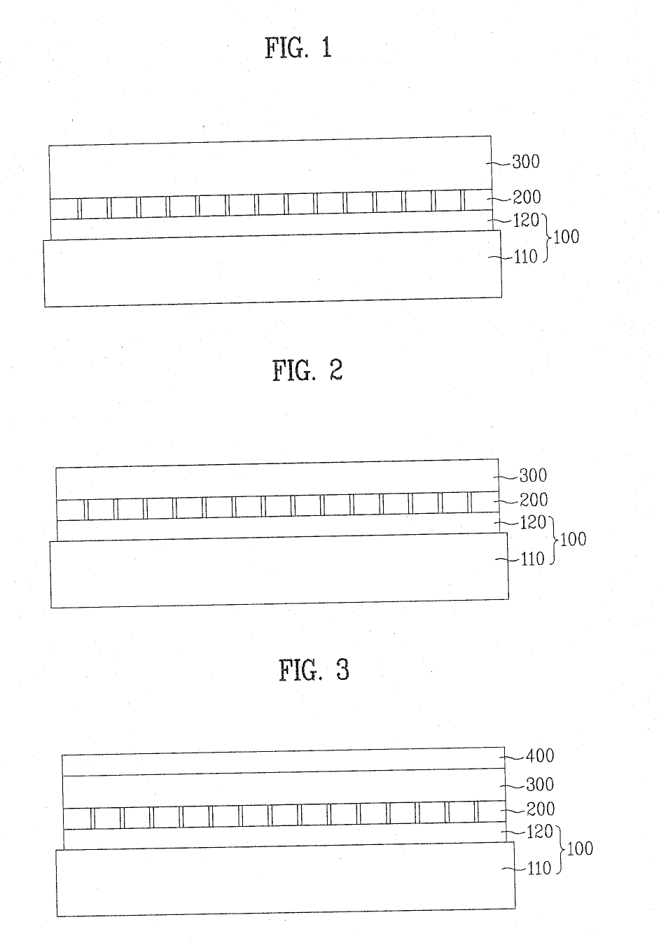

FIG. 1 shows one embodiment of an electro-luminescent device that includes an insulating substrate 100 formed from a metal substrate 110 and an insulating layer 120. The insulating layer 120 may be made of a ceramic sheet or an insulating material layer formed over metal substrate 110.

A lower electrode 200 is formed on the insulating substrate and patterned to have a particular pattern, for example, a stripe-shaped pattern. The lower electrode may be formed, for example, by depositing a metal such as copper (Cu), chromium (Cr), or gold (Au) in accordance with a sputtering method. The lower electrode may also be made of silver (Ag) or an alloy containing silver.

When silver or a silver-containing alloy is used, lower electrode 200 may be formed using a printing method or a green sheet method. When the lower electrode is formed using silver or silver alloy, it is possible to thickly form the lower electrode using a simple process.

That is, the above-described printing method and green sheet method can form the lower electrode through a simple process, without requiring expensive equipment which is required to be used compared to other methods, for example, the sputtering method. Also, the printing method and green sheet method can thickly form the lower electrode 200 compared to other methods, for example, the sputtering method.

A lower dielectric layer 300 may be formed on the lower electrode. Formation of the lower dielectric layer 300 can be achieved, for example, through one deposition process. Alternatively, the lower dielectric layer may be formed using a green sheet method or a table coating method.

The lower dielectric layer has breakdown characteristics and functions to protect the device from external impurities, all of which contribute to the stability of the device. The lower dielectric layer may also play an important role in determining the light emission efficiency and brightness characteristics of the device, in accordance with the condition of the interface between the lower dielectric layer 300 and a phosphor layer.

When lower dielectric layer 300 is formed using a green sheet method or a table method, it is possible to uniformly and thickly form the lower dielectric layer. In accordance with one embodiment, the lower dielectric layer may exhibit a ferroelectric property, e.g., the lower dielectric layer may be made of a material containing BaTiO₃.

When the lower dielectric layer is formed using a green sheet method, the lower dielectric layer can be formed by first forming a green sheet containing dielectric powder on the lower electrode 200, using a laminator or the like, and then drying the green sheet. The green sheet for the lower dielectric layer may comprise dielectric powder and at least one of a dispersing agent, a binder, and a plasticizer. The green sheet may be formed to have a desired thickness, for example, by preparing a slurry of the above-described materials, shaping the slurry, and drying the shaped slurry.

In accordance with one embodiment, the green sheet has a composition comprising 47 to 70 wt. % of dielectric powder, 1 to 3 wt. % of a dispersing agent, 20 to 35 wt. % of a binder, and 8 to 15 wt. % of a plasticizer. The dielectric powder may comprise ferroelectric powder.

The lower structure of the electro-luminescent device, which includes insulating substrate 100, lower electrode 200, and lower dielectric layer 300, may be completely formed after the elements of the lower structure are simultaneously cured, as shown in FIG. 2. During the curing process, organic substances contained in the green sheet are burned. As a result, the green sheets constituting the lower electrode and lower dielectric layer are reduced in thickness.

When the lower electrode and lower dielectric layer are simultaneously cured through a single curing process, the curing temperature in the curing process may be 700 to 850° C. This curing process is possible when a metal substrate 110 is used for the insulating substrate 100.

Simultaneous curing of the lower electrode and lower dielectric layer through one curing process can be achieved, for example, by appropriately controlling the size of metal powder contained in an electrode material for lower electrode 200 and the transition temperature Tg of glass frit used in the curing process, in accordance with the aforementioned curing temperature range.

Also, the composition of the green sheet for the lower dielectric layer 300 can be optimized in accordance with the above-described curing temperature. When the lower dielectric layer is cured at a high temperature as described above, the sintering density and packaging density of the lower dielectric layer increase so that the characteristics of the device can be improved as a whole.

Of course, the curing process can be carried out at a lower temperature. For example, the curing process may be performed at a temperature of 500 to 700° C. In this case, the composition of the green sheet for the lower dielectric layer and the composition of the material of the lower electrode can be controlled in accordance with the above-described temperature range.

Also, in accordance with one or more embodiments, the lower dielectric layer may have single layer structure other than a multilayer structure, using a green sheet as described above.

A planarizing layer 400 may be subsequently formed over the lower dielectric layer 300. The planarizing layer may be formed, for example, using a spin coating method. According to one alternative embodiment, the curing process may be carried out after formation of the planarizing layer, so that the planarizing layer is cured simultaneously with lower electrode 200 and lower dielectric layer 300.

In one or more embodiments, the lower dielectric layer of the electro-luminescent device may have a multilayer structure formed from a plurality of dielectric layers. In order to form such a multilayer structure, a plurality of interlayers such as anti-cracking layers may be interposed or otherwise included in the multilayer structure. The multiple dielectric layers and multiple interlayers may be independently formed and cured. For this reason, it may be beneficial to conduct the curing process several times or several tens of times, to form the above-described lower structure of the electro-luminescent device.

When lower dielectric layer 300 is formed to have a single layer structure using a green sheet method and cured together with lower electrode 200, it is possible to completely form the lower structure of the electro-luminescent device only through one curing process. Thus, it is possible to reduce the number of processes, the processing time, and the manufacturing costs compared with other methods. If desired, the planarizing layer 400 may be dispensed with.

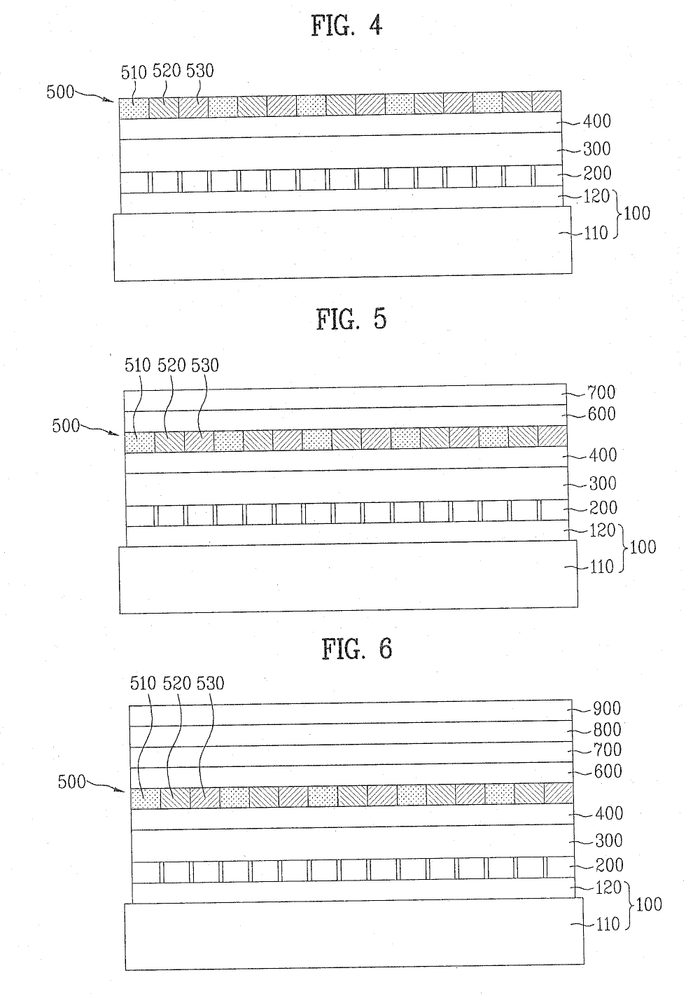

In a next step, a phosphor layer 500 is formed on the lower dielectric layer 300 or planarizing layer 400 as shown in FIG. 4. The phosphor layer may comprise a red phosphor 510, a green phosphor 520, and a blue phosphor 530, which are preferably sequentially formed or patterned to form light emitting cells. The three kinds of phosphors may correspond to sub-pixels that together constitute one pixel. That is, each pixel in the display device may include sub pixels respectively formed by red, green, and blue phosphors such as shown by reference numerals 510, 520, and 530.

An upper dielectric layer 600 and an upper electrode 700 may be sequentially formed over the phosphor layer as shown in FIG. 5. The upper dielectric layer can be formed in the same manner as that of the lower dielectric layer. The upper electrode 700 may be formed to have a pattern crossing the lower electrode 200. For example, the upper electrode may have a stripe-shaped pattern orthogonal to the pattern of the lower electrode.

As shown in FIG. 6, a color correcting layer 800 may be formed on the upper electrode 700, to correct light emitted from the phosphor layer 500 such that the light meet desired color coordinates.

A passivation layer 900 may be formed over the color correcting layer 800 to protect the insulating substrate 100 and the structure formed on the insulating substrate 100 from external impact.

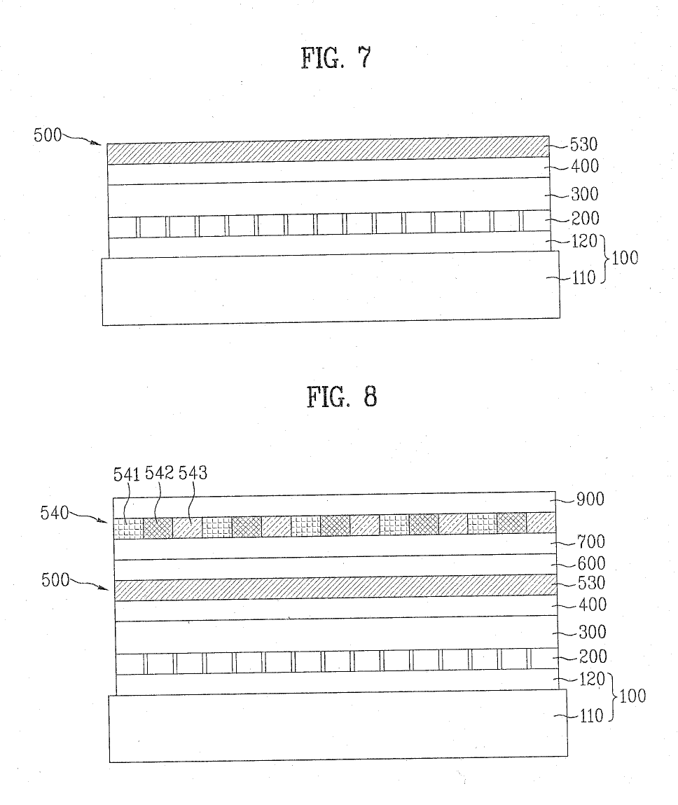

In an alternative embodiment, the phosphor layer 500, which is formed over the planarizing layer 400, may comprise only a blue phosphor 530 as shown in FIG. 7.

Similar to the previous case, upper dielectric layer 600 and upper electrode 700 may be sequentially formed over the phosphor layer 500.

Blue light emitted from the blue phosphor 530 is converted to red light and green light by a color converting layer 540, which is arranged on the upper electrode 700. Thus, it is possible to render all colors using only a single-color phosphor layer.

As indicated, the color converting layer 540 can convert blue light emitted from the blue phosphor 530 to red light and green light, as described above.

In this case, the passivation layer 900 is arranged over the color converting layer 540, to protect the insulating substrate 100 and the structure formed on the insulating substrate 100 from external impact.

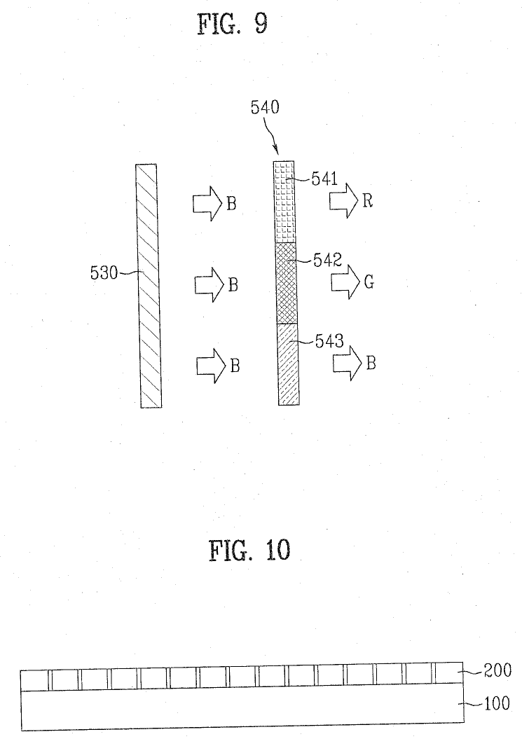

FIG. 9 shows one way in which the color converting layer 540 may function. As shown in FIG. 9, the color converting layer includes a red converter 541, a green converter 542, and a blue corrector 543. The red converter converts blue light to red light, whereas the green converter converts blue light to green light. The blue corrector 543 may correct the blue light or may allow the blue light to pass therethrough without being corrected.

A separate color correcting layer may be arranged on the color converting layer 540. However, if the color converting layer can output all colors meeting optimal color coordinates, it may be unnecessary to provide the color correcting layer.

A second embodiment of an electro-luminescent device will be described with reference to FIGS. 10 to 14. Elements in the second embodiment similar to those in the first embodiment may be given similar reference numerals.

As shown in FIG. 10, a lower electrode 200 is formed on an insulating substrate 100. The lower electrode may be patterned to have a particular pattern, for example, a stripe-shaped pattern.

In this embodiment, a glass substrate may be used for the insulating substrate. For the glass substrate, a glass substrate having a high melting point may be used. Under these circumstances, the glass substrate may be cured at a temperature of up to 700° C.

The lower electrode 200 may be formed by depositing a metal such as copper (Cu), chromium (Cr), or gold (Au) in accordance with a sputtering method. The lower electrode may also be made of silver (Ag) or silver alloy. When the silver or silver alloy is used, the lower electrode may be formed using a printing method or a green sheet method. These configurations may be identical to those of the first embodiment.

A lower dielectric layer 300 is formed on the lower electrode as shown in FIG. 11. Formation of the lower dielectric layer can be achieved through one deposition process. Alternatively, the lower dielectric layer may be formed using a green sheet method.

The lower electrode and lower dielectric layer formed on the glass substrate may be simultaneously cured through a single curing process. In this case, the curing temperature may be 500 to 700° C.

The simultaneous curing of the lower electrode and lower dielectric layer through one curing process can be achieved by appropriately controlling the size of metal powder contained in an electrode material for the lower electrode and the transition temperature Tg of glass frit used in the curing process, in accordance with the curing temperature range of 500 to 700° C. allowed for the glass substrate.

Also, the composition of the green sheet rot lower dielectric layer 300 can be optimized in accordance with the above-described curing temperature.

The lower dielectric layer 300 may have single layer structure other than a multilayer structure, using a green sheet.

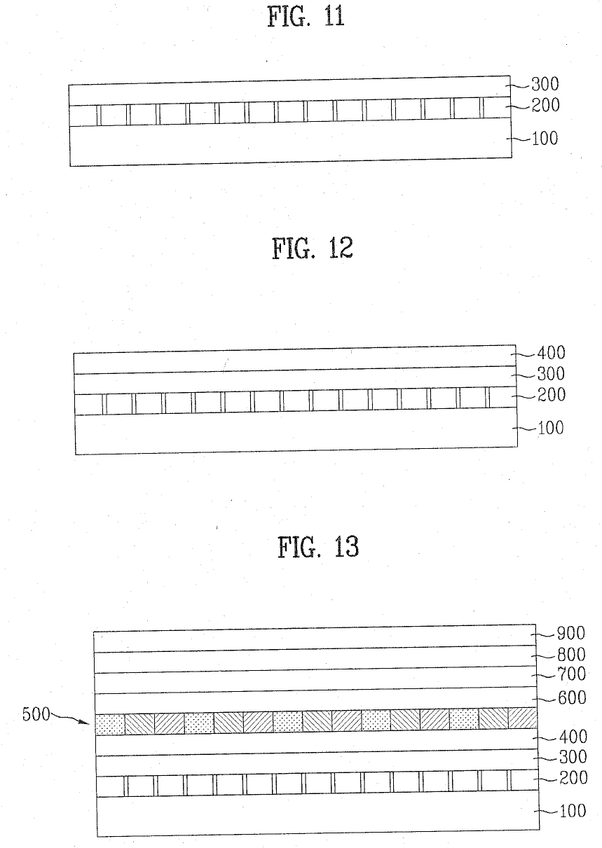

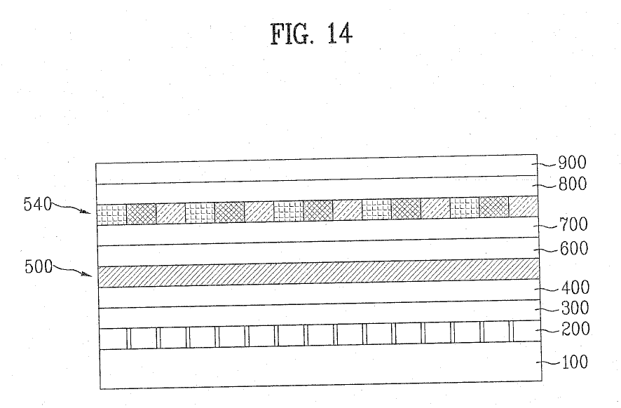

As shown in FIG. 12, a planarizing layer 400 may be subsequently formed over the lower dielectric layer to provide a planarized surface. The planarizing layer may be formed, for example, using a spin coating method.

According to one embodiment, the curing process may be carried out after formation of the planarizing layer so that the planarizing layer may be cured simultaneously with the lower electrode and lower dielectric layer.

Thereafter, as shown in FIG. 13, a phosphor layer 500 is formed on planarizing layer 400 formed in the above-described manner. The phosphor layer may comprise a red phosphor 510, a green phosphor 520, and a blue phosphor 530, which are sequentially formed or patterned to form light emitting cells.

An upper dielectric layer 600 and an upper electrode 700 may be sequentially formed over the phosphor layer. The upper dielectric layer can be formed in the same manner as that of the lower dielectric layer.

The upper electrode 700 may be formed to have a pattern crossing the lower electrode 200. For example, the upper electrode may have a stripe-shaped pattern orthogonal to the pattern of the lower electrode.

A color correcting layer 800 may be formed on the upper electrode to correct light emitted from the phosphor layer, so that the light meets desired color coordinates. A passivation layer 900 may be formed over the color correcting layer 800 to protect the insulating substrate, and the structure formed on the insulating substrate, from external impact.

In an alternative embodiment, the phosphor layer 500, which is formed over planarizing layer 400, may comprise only a blue phosphor 530 as shown in FIG. 14. Blue light emitted from the blue phosphor is converted to red light and green light by a color converting layer 540. Thus, it is possible to render all colors. This configuration may be identical to that of the first embodiment.

In this case, upper dielectric layer 600 and upper electrode 700 may be sequentially formed over the phosphor layer 500, which comprises only the blue phosphor 530. The color converting layer 540 is formed over the upper electrode 700.

A separate color correcting layer 800 may be arranged on the color converting layer 540 to correct the colors of light converted by the color converting layer. However, if the color converting layer can output all colors meeting optimal color coordinates, it may be unnecessary to provide color correcting layer 800.

A passivation layer 900 may be formed over the color correcting layer 800 to protect insulating substrate 100, and the structure formed on the insulating substrate, from external impact.

In accordance with one or more embodiments described herein, an electro-luminescent device and a method for manufacturing the same is provided that substantially obviates one or more problems due to limitations and disadvantages of the related art. In accordance with one embodiment, an electro-luminescent device and a method for manufacturing the same is provided, which can reduce the number of curing processes, to thereby achieve a reduction in the number of processes. Such an embodiment may enhance of the film uniformity of dielectric layers and other layers, to achieve an enhancement in light emission efficiency. The electro-luminescent device may be an inorganic type or an organic type.

In accordance with one embodiment, a method for manufacturing an electro-luminescent device comprises: forming an electrode on an insulating substrate; forming a dielectric layer over the electrode, using a green sheet method; and simultaneously curing the electrode and the dielectric layer.

In another embodiment, an electro-luminescent device comprises: an insulating substrate; an electrode arranged on the insulating substrate; a dielectric layer arranged on the electrode; and a planarizing layer directly formed on the dielectric layer.

In another embodiment, an electro-luminescent device comprises: an insulating substrate; an electrode arranged on the insulating substrate; and a dielectric layer arranged on the electrode, wherein the dielectric layer is prepared, using a green sheet, and is cured, simultaneously with the electrode.

It will be understood that when an element such as a layer, region or substrate is referred to as being “on” another element, it can be directly on the other element or intervening elements may also be present.

It will be understood that these terms are intended to encompass different orientations of the device in addition to the orientation depicted in the figures. Finally, the term “directly” means that there are no intervening elements. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms.

These terms are only used to distinguish one region, layer or section from another region, layer or section. Thus, a first region, layer or section discussed below could be termed a second region, layer or section, and similarly, a second region, layer or section may be termed a first region, layer or section without departing from the teachings of the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for manufacturing an electro-luminescent device, comprising:
forming an electrode on an insulating substrate;
forming a dielectric layer over the electrode using a green sheet method; and
simultaneously curing the electrode and the dielectric layer.

2. The method of claim 1, further comprising:
forming a planarizing layer over the dielectric layer.

3. The method of claim 2, wherein the planarizing layer is cured simultaneously with the curing of the electrode and the dielectric layer.

4. The method of claim 1, wherein the insulating substrate comprises a metal substrate or a glass substrate.

5. The method of claim 4, wherein said curing is executed at a temperature range of between 700 to 850° C. when the metal substrate is used for the insulating substrate.

6. The method of claim 4, wherein said curing is executed at a temperature range of 500 to 700° C. when the glass substrate is used for the insulating substrate.

7. The method of claim 1, further comprising:
forming at least one phosphor layer over the dielectric layer.

8. The method of claim 7, wherein forming the at least one phosphor layer comprises: forming a plurality of phosphor layers to emit red (R) light, green (G) light, and blue (B) light respectively.

9. The method of claim 7, wherein forming the at least one phosphor layer comprises: forming only one phosphor layer to emit blue (B) light.

10. The method of claim 9, further comprising:
forming, over the at least one phosphor layer, a color converting layer to convert the blue (B) light to red (R) light and green (G) light.

11. The method of claim 7, further comprising:
forming a color correcting layer to color-correct light emitted from the phosphor layer.

12. The method of claim 1, wherein the dielectric layer is formed using a green sheet that comprises a dielectric powder, a dispersing agent, a binder, and a plasticizer.

13. The method according to claim 1, wherein the electrode is formed using a printing method or a green sheet method.

14. An electro-luminescent device comprising:
an insulating substrate;
an electrode arranged on the insulating substrate;
a dielectric layer arranged on the electrode; and
a planarizing layer directly formed on the dielectric layer.

15. The electro-luminescent device of claim 14, further comprising:
at least one phosphor layer arranged on the dielectric layer.

16. The electro-luminescent device of claim 15, wherein the at least one phosphor layer comprises a plurality of phosphor layers to emit red (R) light, green (G) light, and blue (B) light respectively.

17. The electro-luminescent device of claim 15, wherein the at least one phosphor layer comprises only a phosphor layer to emit blue (B) light.

18. The electro-luminescent device of claim 17, further comprising:
a color converting layer formed over the at least one phosphor layer to convert the blue (B) light to red (R) light and green (G) light.

19. The electro-luminescent device of claim 15, further comprising:
a color correcting layer formed on the at least one phosphor layer to color-correct light emitted from the phosphor layer.

20. The electro-luminescent device of claim 14, wherein the insulating substrate comprises:
a metal substrate; and
an insulating layer arranged on the metal substrate.

21. The electro-luminescent device of claim 14, wherein the dielectric layer has a single layer structure.

22. The electro-luminescent device of claim 14, wherein the dielectric layer is a lower dielectric layer.

23. The electro-luminescent device of claim 14, wherein the dielectric layer is made of a ferroelectric material.

24. The electro-luminescent device of claim 14, wherein the electrode is made of Ag or an alloy containing Ag.

25. An electro-luminescent device comprising:
an insulating substrate;
an electrode arranged on the insulating substrate; and
a dielectric layer arranged on the electrode, wherein the dielectric layer is prepared using a green sheet and is cured simultaneously with the electrode.
